(19) United States
(12) Patent Application Publication
(10) Pub. No.: US 2002/0030772 A1
(43) Pub. Date: Mar. 14, 2002

(54) Display device

(75) Inventors: Tore Nauta, Eindhoven (NL); Antonius Hendricus Maria Holtslag, Eindhoven (NL); Dirk Jan Broer, Eindhoven (NL); Hendrik De Koning, Eindhoven (NL); Hugo Johan Cornelissen, Eindhoven (NL); Jacob Bruinink, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/944,318

(22) Filed: Aug. 31, 2001

(30) Foreign Application Priority Data
Sep. 11, 2000 (EP) 00203128.4

(51) Int. Cl. G02F 1/1335

(52) U.S. Cl. 349/61

(57) ABSTRACT

Display device based on the scanning window principle in which uniform light segments (30) are obtained via light sources, or backlights, (12, 40) which introduce light into a side (10) of a waveguide (15). Segments are defined via liquid crystal switches, or shutters, (21) or parts of a row of LEDs (40).

The invention relates to a display device comprising a display panel having a first light-transmissive substrate provided with electrodes at the area of pixels arranged in rows and columns, a second light-transmissive substrate and electro-optical material between the two substrates, an illumination system situated on the side of the second substrate remote from the electro-optical material, said illumination system comprising an optical waveguide of an optically transparent material having an exit face facing the display panel.

Display devices of this type are used in, for example, portable apparatus such as laptop computers, mobile telephones, personal organizers etc. but also in, for example, television applications.

The invention also relates to an illumination system for use in such a display device.

A display device of the type mentioned above is described in U.S. Pat. No. 5,103,328. This document shows a liquid crystal switch built up of separate switchable segments between a flat light source (backlight) and a display panel. The liquid crystal switch is adapted in such a way that a plurality of rows of pixels of the display panel corresponds to one segment and its function is to shield pixels that are written in from the light coming from the backlight.

Each segment is coupled to one part of the switch, which part switches separately. By consecutively illuminating different, subsequent rows of pixels via the associated part of the switch in such a device, scanning window applications are possible, in which the light from the backlight is presented in the form of strips. The switch covers a surface area having the size of the surface area of the display panel. Also the light from the backlight must cover this surface area, which does not only require more material but also imposes stringent requirements on the quality of said backlight, due to the desired uniformity of the exiting light.

It is, inter alia, an object of the present invention to obviate these drawbacks as much as possible. It is another object of the invention to provide an illumination system which is easily replaceable.

To this end, a display device according to the invention is characterized in that the optical waveguide comprises means for selectively coupling out light to the display panel for a group of rows of pixels or a group of columns of pixels and is provided with means for coupling in light in a direction which is substantially parallel to the exit face.

The wording “substantially parallel to the exit face” is herein understood to mean that light beams are coupled in in such a way that, on average, they are displaced parallel to the exit face but, locally, the light beams may extend at an angle to a plane which is parallel to the exit face (up to, for example, at most 50°).

The light is now coupled into the optical waveguide from, for example, an edge of the waveguide. The light beam to be coupled in has considerably smaller dimensions than the surface area of the display panel. This surface area is now determined, for example, by the width of a light strip (which is a part of, for example, the total height of the display panel) and the thickness of the optical waveguide (which is usually considerably smaller than, for example, the overall width of the display panel). This makes it easier to couple in light of one intensity into the optical waveguide (uniform light source).

The light beam may also be coupled in through, for example, the entire width of the optical waveguide, in which the light is sequentially coupled out in the form of strips into the direction of the display panel. However, the switch, which is divided into a plurality of sub-switches, fills a surface area having the size of the surface area of the display panel.

A preferred embodiment of a display device according to the invention is therefore characterized in that the illumination system comprises at least one backlight and an optical waveguide having at least one entrance face for light, while light from the backlight can be coupled in along the entrance face extending substantially transversely to the exit face, and a selectively switchable light switch is situated between the backlight and the entrance face.

The entrance face is situated, for example, along an end face of the optical waveguide extending substantially transversely to the rows, while light from the backlight can be coupled in along this end face. The selectively switchable light switch then comprises, for example a liquid crystal switching device with a liquid crystal between two substrates, one or both of which (for example, on the side of the liquid crystal) may be provided with strip-shaped electrodes. The backlight does not only have a much smaller surface area than in the conventional display device, but the light switch is also much smaller and can therefore be manufactured at lower cost. Consequently, the backlight and the light switch can be easily integrated to one assembly. Substitution of such a combination is simpler than in the known device because alignment in only one dimension is necessary.

A second preferred embodiment according to the invention is characterized in that the illumination system comprises sub-segments and at least one backlight with an entrance face for light for each sub-segment, while light from the backlight can be coupled into the sub-segments. It is true that the device now comprises more switches but these do not need to be divided into sub-switches.

A further preferred embodiment according to the invention is characterized in that the illumination system comprises at least one backlight and has an entrance face for light at the area of the optical waveguide, while light from the backlight can be coupled in along an entrance face extending substantially transversely to the exit face, and parts of the backlight are selectively switchable between an on-state having a high light intensity and an off-state. This can be achieved with a set of, for example, LEDs but also with fluorescent lamps, in which switching takes place between an on-state and an off-state and the lamp is not necessarily switched off but emits light having a sufficiently low intensity to ensure a satisfactory contrast.

Since the pixels need a certain time to reach their definitive adjustment, notably in liquid crystal display devices, the display device preferably comprises drive means for presenting signals to data and column electrodes for the purpose of writing pixels, and for selectively activating a part of the illumination system associated with the group of rows of pixels, the drive means introducing a delay between the presentation of the signals to the data and column electrodes and the selective activation of the part of the illumination system associated with the group of rows of pixels.

An illumination system according to the invention comprising an optical waveguide of an optically transparent material having an exit face and means for coupling in light on at least one entrance face into a direction which is parallel to the exit face, is characterized in that the optical waveguide is provided with means for selectively coupling in light for a part of the exit face.

These and other aspects of the invention are apparent from and will be elucidated with reference to the embodiments described hereinafter.

### IN THE DRAWINGS

FIG. 1 is a diagrammatic perspective view of an embodiment of a display device according to the invention,

FIG. 2 is a diagrammatic plan view of the illumination system used in the embodiment shown in FIG. 1,

FIG. 3 is a cross-section taken on the line III-II in FIG. 2,

FIGS. 4 to 6 are diagrammatic cross-sections of variants of a part of the illumination system shown in FIGS. 1, 2,

FIGS. 7 to 9 are diagrammatic plan views of various illumination systems according to the invention, while

FIG. 10 is a cross-section taken on the line X-X in FIG. 9, and

FIG. 11 shows a variant of the illumination systems shown.

The Figures are diagrammatic and not drawn to scale. Corresponding parts are generally denoted by the same reference numerals.

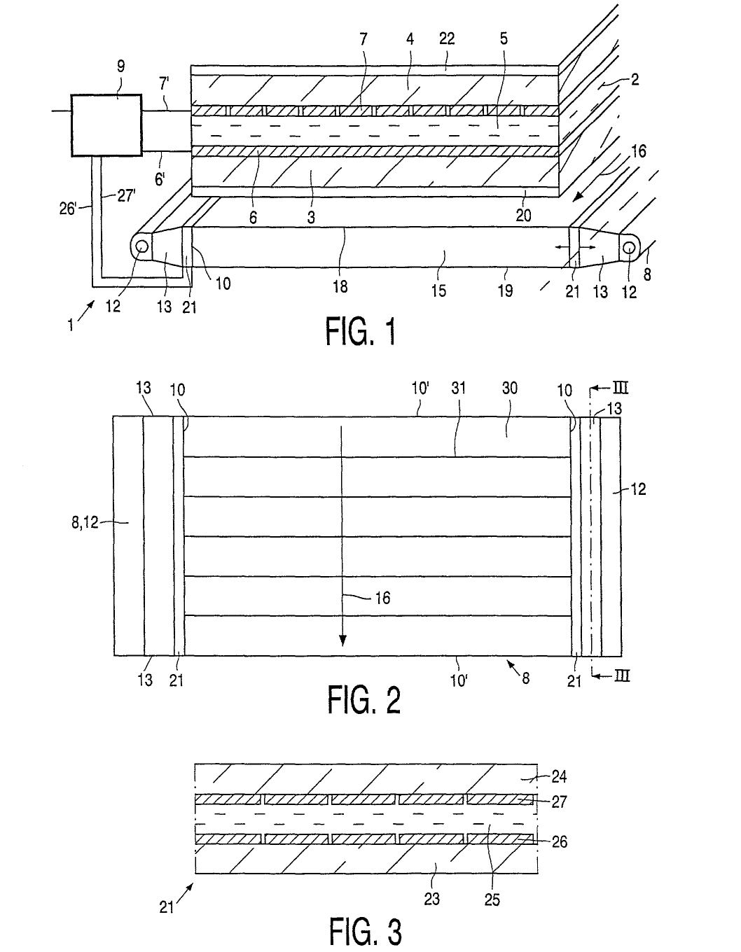

The display device 1 shown diagrammatically in FIGS. 1 and 2 comprises a display panel 2 and an illumination system 8.

The display panel 2 comprises, between two substrates 3, 4, an electro-optical material, in this embodiment a liquid crystalline material 5 whose operation is based on, for example, the twisted-nematic (TN), the supertwisted-nematic (STN) or the ferroelectrical effect for modulating the direction of polarization of light incident thereon. The display panel comprises, for example, a matrix of pixels for which transparent picture electrodes 6 are arranged on the substrate 3. An active matrix (drive with separate switches) is preferably used in this case. The substrate 4 is light-transmissive and has light-transmissive electrodes 7 of, for example, ITO (indium tin oxide). The picture electrodes are provided with electric voltages via connection wires 6′, 7′ which are provided with drive voltages by means of a drive unit 9. Moreover, the display panel is customarily provided with a polarizer 20 and an analyzer 22.

The illumination system 8 comprises an optical waveguide 15 made of an optically transparent material and having four end faces 10, 10′. A light source, or backlight, 12 whose light is coupled into the optical waveguide 15 via the end face 10 is arranged opposite one of the end faces, for example, 10. The backlight 12 may be, for example, a rod-shaped fluorescence lamp. The backlight may be alternatively constituted, for example, by one or more light-emitting diodes (LED), notably in flat-panel display devices having small display panels such as, for example, in portable televisions. Moreover, the backlight 12 may be detachable.

The exit face 18 of the optical waveguide 15 faces the display panel 2. Each end face 10′ of the transparent plate, into which no light is coupled, may be provided with a reflector. In this way, light which is not coupled out on the exit face 18 and consequently propagates through the waveguide and reaches an end face 10′ is prevented from leaving the waveguide 15 via this end face 10′.

To avoid that light leaves the waveguide 15 without contributing to the light output of the illumination system, light from the lamp 12 is preferably coupled into the waveguide 15 via coupling-in means 13, for example, by means of a wedge-shaped optical waveguide which limits the angle of the entering beam to 15 degrees with respect to the faces 18, 19.

The display device 1 shown is driven in the scanning-window mode. This means that groups of row electrodes (for example, the electrodes 6) are consecutively illuminated with a beam having the width of the group of row electrodes. In this embodiment, the light beam is displaced in the direction of arrow 16.

This is achieved, for example, by means of a liquid crystal shutter 21. This shutter comprises, for example, between two substrates 23, 24, a liquid crystalline material 25 whose operation is based again on, for example, a twisted-nematic (TN), the supertwistednematic (STN) or the ferroelectrical effect, or, for example, on an LC gel system obtained by crosslinking of LC monomers switching between a transparent and an absorbing state. The shutter, or switch, 21 comprises strip-shaped light-transmissive transparent picture electrodes 26, 27 on the light-transmissive substrates 23, 24. The strip-shaped electrodes are provided with electric voltages via connection wires 26′, 27′ which are provided with drive voltages by means of said drive unit 9. If necessary, also the shutter 21 is provided with polarizers in a conventional manner.

The drive unit 9 is adapted to be such that the strip-shaped parts 30 consecutively become light transmissive (opened) after the related rows of pixels (and the columns of pixels in another embodiment to be described) have been provided with information. In connection with a possible inertia in the liquid crystal material in the display device 2, a minimal waiting time is preferably observed for opening the associated parts of the shutter 21.

The embodiment of the illumination system shown has a plurality of advantages over the system as shown in U.S. Pat. No. 5,592,193. For example, the light beam enters on a surface area having the size of the surface area of an end face 10 of the optical waveguide. This surface area is much smaller than the exit face 18 so that a light beam having a uniform light intensity can be generated more easily. Moreover, the backlight no longer needs to be positioned in two dimensions (those of the rows and columns) but only the electrodes 26, 27 are to be positioned with respect to the strip-shaped parts (segments) 30. Since the interface between the light shutter 21 and the waveguide 10 is situated outside the area of view of the display device, for example, special (mechanical) marks can be provided for this purpose. This makes it attractive to form the combination of backlight and light shutter as one detachable assembly. Since the shutter is smaller, it requires less material. Due to the small dimension, the filling rate increases, also at smaller thicknesses of the layer of electro-optical material in the shutter. The smaller thickness in turn leads to faster switching times.

To avoid that the light beam acquires a larger width than the segments 30 due to divergence in the optical waveguide, the optical waveguide is provided with narrow areas having a lower refractive index at the interface 31 between two segments. These areas may be, for example, narrow grooves which may also serve as said (mechanical) marks. The grooves may be situated, for example, on the exit face 18 but may also be situated simultaneously on the facing face 19. The segments may be alternatively separated by reflectors.

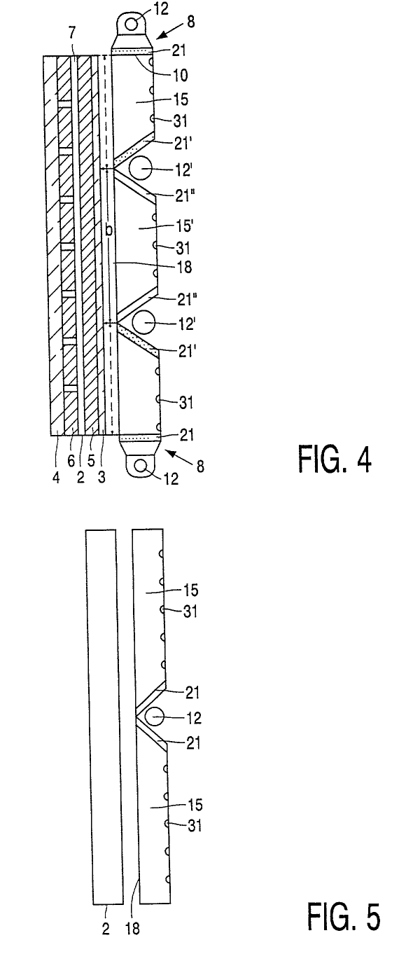

In the display device of FIGS. 1, 2, 3, light emitted by the backlight 12 is absorbed by only one of the segments. A large part of the emitted light is therefore still absorbed in the light shutter 21. This is partly prevented in the device of FIG. 4, in which light only exits at the location of one segment 30 (selected at that instant). Each strip-shaped part (segment) 30 is now situated between two backlights 12, 12′ and is separated therefrom by light shutters 21, 21′, 21′ extending at an angle of 45° to the exit face 18. In the situation as shown in FIG. 4, for example, only the switches 21′ are light-transmissive, whereas the switches 21, 21′ do not transmit light. Consequently, only a light beam having a width b is coupled out by the part 15′ of the optical waveguide. No light is coupled out at the location of the other parts. Unnecessary loss of light (and dissipation) can be further limited by temporarily switching off the backlights which do not contribute (in this embodiment, the lamps 12 on the end faces 10 of the optical waveguide 15). Other reference numerals in the Figures have the same significance as in the previous embodiments.

FIG. 4 is very diagrammatic. In practice, the backlights are arranged in, for example, grooves in the substrate, with light shutters between the backlights and the segments, while the grooves are covered with absorbing or reflective material at areas where no light coupling is desired.

FIG. 5 shows a variant of FIG. 4, in which two segments 30 are illuminated with a minimal number of components (two light shutters 21 and one backlight 12).

In the embodiments shown, there is still absorption in the light shutters 21. A maximum light output is obtained by choosing switchable reflective mirrors for these light shutters 21.

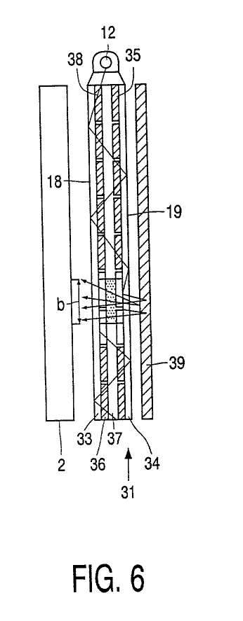

The display device of FIG. 6 shows an alternative in which the light shutter forms part of the optical waveguide. Light from the lamp 12 is coupled via coupling means 13 into the waveguide (light shutter) 31 which is formed as a liquid crystal shutter. It comprises, again between two parallel substrates 33, 34, for example, a liquid crystalline material 35 whose operation may be based again, for example, on the twisted-nematic (TN), the supertwisted-nematic (STN) or the ferroelectrical effect, but is preferably based on a scattering effect. The shutter, or switch, 31, which now also functions as an optical waveguide, comprises, on at least one substrate, strip-shaped light-transmissive transparent picture electrodes 36, 37 on the light-transmissive substrates 33, 34. The strip-shaped electrodes are provided with electric voltages via drive means as described above. The liquid crystal material or another suitable electro-optical material, for example, electrophorectic material now becomes either transparent or scattering. Light beams 38 from the backlight 12 remain within the optical waveguide 31 due to total reflection (the assembly functions as a waveguide) except at the area of energized electrodes where light scattering occurs in the direction of the display panel 2 (indicated as beam b). The reflector 39 serves to reflect light leaving the waveguide-shutter combination 31 via the surface 19 to the display panel 2 or the waveguide-shutter combination 31. Dependent on the type of use, this reflector may be formed as a diffuse or as a specular reflector.

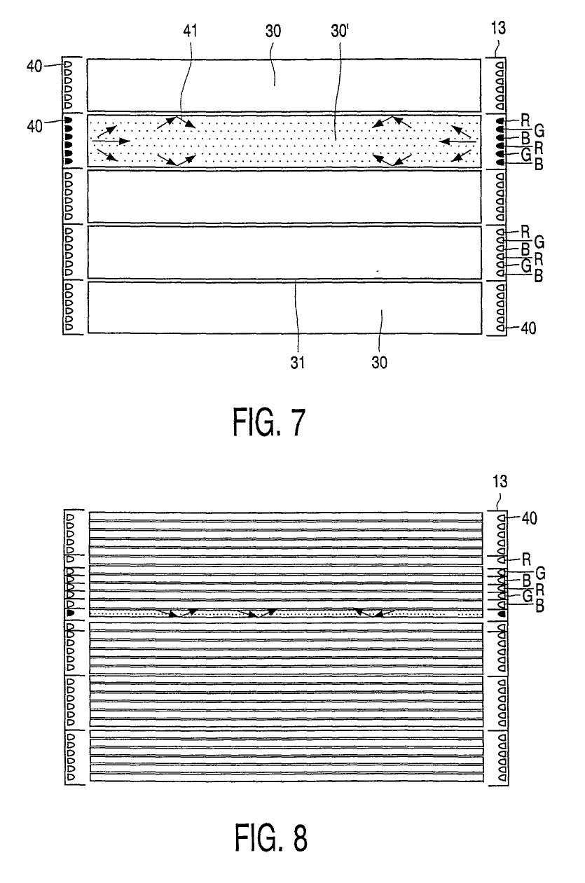

FIG. 7 shows a variant of FIG. 2. The backlight is now constituted by separately switchable LEDs 40. As described, light from the LEDs 40 is coupled into the optical waveguide 15 preferably via coupling means 13. Grooves 31 between the segments 30 again prevent optical crosstalk between the segments. In FIG. 7, in which one segment is illuminated from both sides with 6 LEDs (2 combinations of a red, a blue and a green LED), this is indicated by arrows 41 in the segment 30′ which is active at that instant. Both in this case and in the variant of FIG. 8, where one segment is illuminated from both sides with one LED per segment, an excellent color mixing is obtained in the optical waveguide. After illuminating a segment, the corresponding LEDs do not need to be completely switched off but may be switched to, for example, a lower operating voltage (at which there is no or hardly any transmission). The other reference numerals have the same significance as in the previous embodiments.

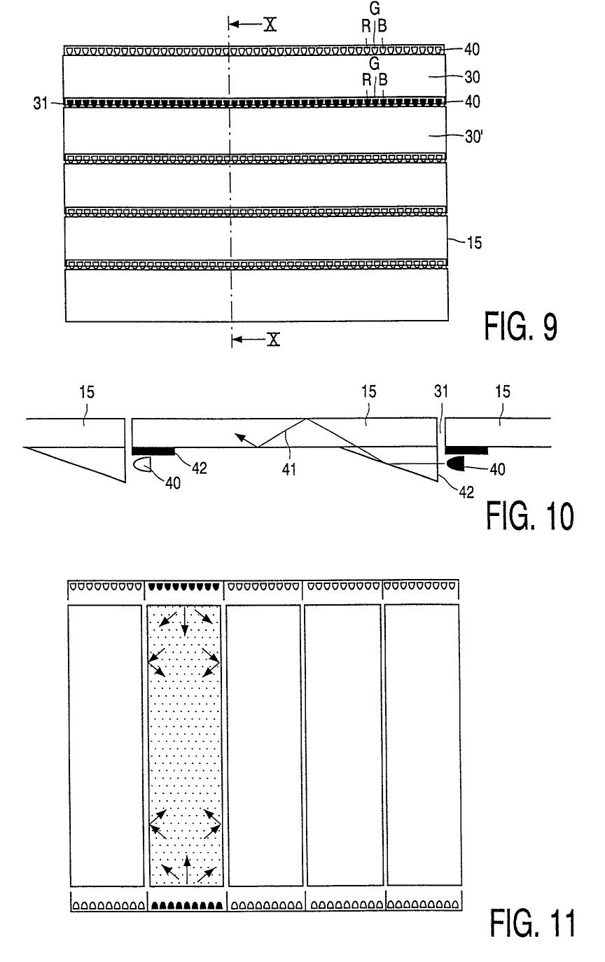

FIGS. 9 and 10 show a variant in which the light output of the illumination system is increased considerably by providing one row of LEDs 40 per segment 30 on the lower side 19 of the optical waveguide, along the grooves 31. Light beams 41 are coupled into the optical waveguide 15 via prismatic elements 42. The rows of LEDs are hidden from view via black strips 43.

The embodiment of FIG. 11 shows a variant of FIG. 7, in which the segments 30 now comprise groups of columns. The advantage of such a device is that there is more space for the LEDs so that more LEDs can be placed and a higher light output is achieved. This is notably attractive for display panels of the 16:9 type. The drive must of course be adapted for such a type of display device. This transposed-scan mode is all the more attractive because fewer D/A converters may be used.

The protective scope of the invention is not limited to the embodiments shown. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device (1) comprising a display panel (2) having a first light-transmissive substrate (3) provided with electrodes (6) at the area of pixels arranged in rows and columns, a second light-transmissive substrate (4) and electro-optical material (5) between the two substrates, an illumination system (8) situated on the side of the second substrate remote from the electro-optical material, said illumination system comprising an optical waveguide (15) of an optically transparent material having an exit face (18) facing the display panel, characterized in that the optical waveguide comprises means for selectively coupling out light to the display panel for a group of rows of pixels or a group of columns of pixels and is provided with means for coupling in light in a direction which is substantially parallel to the exit face.

2. A display device as claimed in claim 1, characterized in that the illumination system (8) comprises at least one backlight (12) and an optical waveguide (15) having at least one entrance face (10) for light, while light from the backlight can be coupled in along the entrance face extending substantially transversely to the exit face (18), and a selectively switchable light switch (21) is situated between the backlight and the entrance face.

3. A display device as claimed in claim 2, characterized in that the illumination system comprises a backlight (12) having an entrance face at the area of at least one end face (10) of the optical waveguide extending substantially transversely to the rows, while light from the backlight can be coupled in along said end face.

4. A display device as claimed in claim 2 or 3, characterized in that the selectively switchable light switch (21) comprises an electro-optical switching device with an electro-optical material (25) between two substrates (23, 24), at least one substrate being provided with strip-shaped electrodes (26, 27).

5. A display device as claimed in claim 1, characterized in that the illumination system comprises sub-segments and at least one backlight (12) with an entrance face for light for each sub-segment, while light from the backlight can be coupled into the sub-segments.

6. A picture display device as claimed in claim 5, characterized in that the light from the backlight can be coupled in along an entrance face extending at an angle to the exit face, and selectively switchable light switches (21) are situated between the backlight and segments of the optical waveguide.

7. A display device as claimed in claim 1, characterized in that the selectively switchable light switch comprises a switchable reflective mirror.

8. A display device as claimed in claim 1, characterized in that the optical waveguide (31) comprises an electro-optical switching device with an electro-optical material (35) between two substrates (33, 34), at least one substrate being provided with strip-shaped electrodes (36, 37) on the side of the electro-optical material.

9. A display device as claimed in claim 1, characterized in that the illumination system comprises at least one backlight having an entrance face for light at the area of the optical waveguide, while light from the backlight can be coupled in along an entrance face extending substantially transversely to the exit face, and parts (40) of the backlight are selectively switchable between an on-state, having a high light intensity, and an off-state.

10. A display device as claimed in claim 9, characterized in that the backlight comprises a prismatic element (42) at the area of the entrance face.

11. A display device as claimed in claim 1, characterized in that the display device comprises drive means (9) for presenting signals to data and column electrodes for the purpose of writing pixels, and for selectively activating a part of the illumination system associated with the group of rows of pixels.

12. A display device as claimed in claim 11, characterized in that the drive means introduce a delay between the presentation of the signals to the data and column electrodes and the selective activation of the part of the illumination system associated with the group of rows or pixels.

13. An illumination system (8) comprising an optical waveguide (15) of an optically transparent material having an exit face (18), and means for coupling light on at least one entrance face (10) in a direction parallel to the exit face, characterized in that the optical waveguide is provided with means for selectively coupling in light for a part of the exit face.

14. An illumination system as claimed in claim 13, characterized in that the illumination system comprises at least one backlight (12) having an entrance face for light at the area of the optical waveguide (15), while light from the backlight can be coupled in along an entrance face (10) extending substantially transversely to the exit face, and a selectively switchable light switch (21) is situated between the backlight (12) and the entrance face.

15. An illumination system as claimed in claim 14, characterized in that the selectively switchable light switch comprises an electro-optical switching device with an electro-optical material (25) between two substrates (23, 24) which are provided with strip-shaped electrodes (26, 27) on the side of the electro-optical material.

16. An illumination system as claimed in claim 13, characterized in that the illumination system comprises sub-segments and at least one backlight (12) with an entrance face for light for each sub-segment, while light from the backlight can be coupled into the sub-segments.

17. An illumination system as claimed in claim 16, characterized in that the light from the backlight can be coupled in along an entrance face extending at an angle to the exit face, and selectively switchable light switches (21) are situated between the backlight and segments of the optical waveguide.

18. An illumination system as claimed in claim 13, characterized in that the selectively switchable light switch comprises a switchable reflective mirror.

19. An illumination system as claimed in claim 13, characterized in that the optical waveguide comprises an electro-optical switching device (31) with an electro-optical material (35) between two substrates (33, 34), at least one substrate being provided with strip-shaped electrodes (36, 37) on the side of the electro-optical material.

20. An illumination system as claimed in claim 13, characterized in that the illumination system comprises at least one backlight having an entrance face for light at the area of the optical waveguide, while light from the backlight can be coupled in along an entrance face extending substantially transversely to the exit face, and parts (40) of the backlight are selectively switchable between an on-state, having a high light intensity, and an off-state.

21. An illumination system as claimed in claim 20, characterized in that the backlight comprises a prismatic element (42) at the area of the entrance face.
